(19) United States
(12) Patent Application Publication
(10) Pub. No.: US 2005/0258565 A1
(43) Pub. Date: Nov. 24, 2005

(54) Method and apparatus for forming a striped extrusion

(76) Inventor: Prem Anand, Waterloo (CA)

Correspondence Address: Ronald J. Kisicki, Esq.;JAECKLE FLEISCHMANN & MUGEL, LLP, Suite 200, 39 State Street, Rochester, NY, 14614-1310, US

(21) Appl. No.: 10/849,339

(22) Filed: May 19, 2004

(51) Int. Cl. B29C 47/06

(52) U.S. Cl. 264/167; 264/173.17; 264/173.18; 425/133.1

(57) ABSTRACT

A polymer extrusion assembly for forming a striped extrusion. The assembly includes conventional components for conveying a primary and a secondary molten polymer of differing colors, arranged concentrically, toward a die sub-assembly, which may be rotatable. The die has an opening for conveying the primary polymer to form an extruded tube. The periphery of the die opening is modified to cause thinning or breaching of the secondary polymer skin layer as it passes through the die. The periphery may be provided with teeth which furrow the skin layer, exposing the primary polymer underneath, or the periphery may be comprise a plurality of facets meeting at sharp internal corners, wherein the skin layer is forced into the corners and is breached at the centers of the facets, again exposing the primary polymer underneath in longitudinal stripes. By causing the die sub-assembly to rotate during extrusion, a spirally striped extrusion is formed.

### TECHNICAL FIELD

The present invention relates to a method and apparatus for extrusion forming of molten polymer material; more particularly, to crossline extrusion heads for continuous extrusion coating of hollow or solid shapes; and most particularly, to an extrusion crosshead having a faceted die for forming a visual stripe in a cylindrically co-extruded element, which stripe may be spirally disposed by rotation of the die during extrusion.

### BACKGROUND OF THE INVENTION

Extrusion heads for continuous extrusion forming of continuous plastic elements having specific cross-sectional shapes are well known. Such extruded elements may include, for example, pipes, rods, moldings, tubings, and the like.

In a typical prior art extrusion system, solid pellets of the thermoplastic material to be used are fed into a progressive-screw extruder wherein the pellets are liquefied under high pressure and are injected into an extrusion head. Such injection may be made axially of the extrusion head, known in the art as “inline,” or at an angle, typically 90°, to the axis of the head, known in the art as “crosshead.” Except when coating highly flexible core materials such as wire, the coating of a sheath layer onto a core stock requires passing the core stock axially through a die and injecting the molten polymer into the die head in a crosshead relationship.

In a typical prior art extrusion crosshead, a generally cylindrical body element concentrically surrounds a generally cylindrical mandrel, a first annular flow space being provided therebetween. Primary molten polymer injected orthogonally from a screw extruder enters an annular reservoir provided in either the body element or mandrel and then flows from the reservoir along the annular flow space. Contiguous with the annular flow space is a conical flow space, formed between a conical choke ring and a conical portion of the mandrel, wherein the diameter of annular flow is decreased and the velocity of flow is increased. Downstream of the conical flow space is a second annular flow space formed between a second cylindrical region of the extruder body and a second cylindrical region of the mandrel. This flow space leads into a flow shaping region formed between an extrusion die and an extrusion tip, from whence the formed shape is extruded.

When it is desired to provide a stripe element in an extruded element, a secondary stripe material is injected radially into the cylindrical flow of the primary polymer, and the striped material is subsequently extruded. When it is desired to provide a spiral stripe in a coating, the extrusion die may be rotated during extrusion.

In the prior art, the co-extrusion of a plurality of such stripes is difficult and costly, requiring either individual additional injection systems for each additional stripe or a complex manifold system within the head to distribute striping polymer to the appropriate angular locations around the primary extrusion. Such manifolding is difficult to machine and assemble. It is especially difficult to even the flow rates among the various stripes, and thus to produce a plurality of stripes of identical width. Further, any desired change in a striping pattern requires design and manufacture of an entirely new distribution manifold.

What is needed in the art is a simple apparatus and method for forming a plurality of visual stripes in the surface of an extruded element, wherein the stripes may be annularly arranged as desired, may be of any individual width as desired, and may be longitudinally or spirally disposed as desired.

It is a principal object of the present invention to provide inexpensive extruded elements having longitudinal or spiral stripes.

It is a further object of the invention to provide simplified means for forming such extruded elements.

### SUMMARY OF THE INVENTION

Briefly described, a polymer extrusion head in accordance with the invention includes a fixed or stationary portion comprising conventional components for admitting, turning, and accelerating a primary molten polymer in a cylindrical stream, which may be annular or columnar, toward a novel die assembly which may be rotatable. The fixed portion of the extrusion head further includes known components for admitting, turning, and accelerating a secondary molten polymer for forming a concentric outer layer of secondary polymer on the cylindrical primary polymer stream. Preferably, the layer of secondary polymer is very thin, defining a “skin” layer. Preferably, the primary and secondary polymers are of contrasting colors or whiteness, such that thinning or breaching of the skin layer will allow the primary polymer layer to become visible as a longitudinal stripe.

Coaxially disposed on the distal end of the fixed section is a rotatable die sub-assembly including a die having a shaped or faceted extrusion opening. The opening has a central region for conveying the primary polymer to form an extruded tube, if compressed air is passed through the mandrel and extrusion tip, or a coated jacket, if core material is passed therethrough. The peripheral region of the die opening may be modified in various ways to cause thinning or breaching of the skin layer as it passes through the die. For one example, the periphery may be provided with one or more short inwardly-projecting protrusions or “teeth” which plow a furrow through the skin layer, exposing the primary polymer underneath, which furrow remains after extrusion and setting, exposing a visual stripe of primary polymer. For another example, the periphery may be formed as a polygon comprising a plurality of flat facets meeting at sharp internal corners. By appropriate manipulation of extrusion flow rate and selection of die dimensions, the skin layer may be distorted to be forced into the sharp corners and virtually breached at the centers of the facets, again exposing the primary polymer underneath in longitudinal stripes. Such distortion may be aided by supplying compressed air within the primary extrusion. By causing the die sub-assembly to rotate while extruding both the primary polymer and the secondary polymer skin layer, a helically striped (spiral) extrusion is formed.

### BRIEF DESCRIPTION OF THE DRAWINGS

The present invention will now be described, by way of example, with reference to the accompanying drawings, in which:

FIG. 1 is an elevational cross-sectional view of a rotatable head assembly in accordance with the invention for forming spirally-striped extrusions;

FIG. 2 is an exit end view of the head assembly shown in FIG. 1;

FIG. 3 is a cross-sectional view of a first embodiment of a die in accordance with the invention, showing extrusion of a furrowed (striped) element;

FIG. 4 is a cross-sectional view of a second embodiment of a die in accordance with the invention, showing extrusion of a faceted (striped) element;

FIG. 5 is an isometric view of an extrusion in accordance with the invention as it would be seen within the apparatus just before entering the die; and

FIG. 6 is a view like that shown in FIG. 5, showing a spirally-striped element having been formed by the die shown in FIG. 5.

### DESCRIPTION OF THE PREFERRED EMBODIMENTS

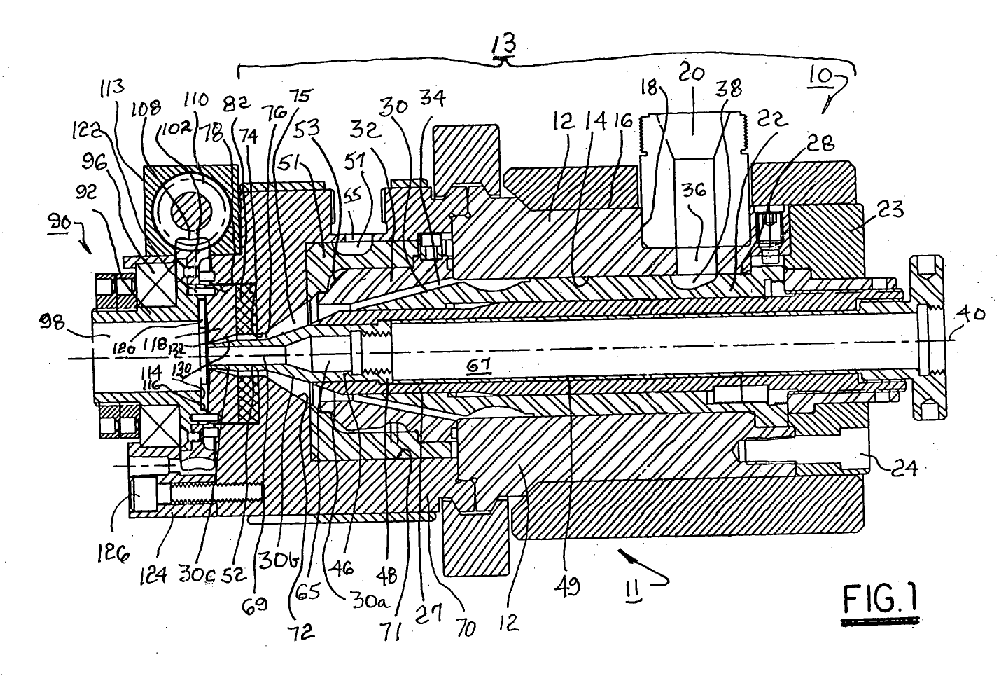

Referring to FIGS. 1 through 3, there is shown an exemplary embodiment 10 of an improved extrusion crosshead assembly in accordance with the invention.

Embodiment 10 comprises a prior art fixed member for providing a flow of primary and secondary polymers to be extruded coextruded, and a rotatable die sub-assembly including a novel die for thinning or breaching the secondary polymer skin to reveal the primary polymer extrusion beneath. Fixed member 11 includes body element 13. A first body section 12 of body element 13 is substantially cylindrical on an inner surface 14 and outer surface 16 thereof. A radial bore 18 therein is receivable of supply means 20 for providing a primary molten polymer to assembly 10 in use thereof. A mandrel 22 is disposed within body section 12 and secured therein via ring 23 and bolts 24. Mandrel 22 includes a cylindrical outer surface portion 28 that is close-fitting to inner body surface 14 and a tapered portion 30. A conically tapered insert 32 cooperates with tapered portion 30 to define a decreasive annular flow space 34. A radial passage 36 in first body section 12 connects bore 18 with an annular reservoir 38 formed in portion 28 for receiving molten primary polymer into the head assembly. By means of reservoir 38 and flow space 34, primary polymer flow through head assembly 10 is converted from columnar flow orthogonal to assembly axis 40 to annular flow through space 34.

Disposed coaxially and snugly within mandrel 22 is a first extrusion tip 27 which extends beyond mandrel tapered portion 30, having its own tapered portion 30a tapered at substantially the same taper angle to continue annular flow space 34. A second extrusion tip 46 is disposed within first tip 27 and includes an annular mounting flange 48, a cylindrical portion 52, and an additional tapered portion 30b. A cylindrical sleeve 49 secures second tip 46 to first tip 27. The mandrel, first tip, second tip, and sleeve are carefully related such that they may be withdrawn and replaced, as may be desired, without requiring any other changes to the overall apparatus.

Second extrusion tip 46 is provided with a stepped axial bore 65 throughout, mated with a bore 67 in sleeve 49. The narrowest portion 69 of bore 65 has a diameter selected for snug but slidable support of core material to be spiral coated, as may be desired.

An intermediate retainer 51 surrounds and retains insert 32. Second body section 70 is coaxially mounted to first body section 12 and includes a first counterbore 71 for receiving and retaining intermediate retainer 51, and for cooperating therewith to provide a second annular polymer flow path 53. Immediately adjacent counterbore 71 is a conically tapered entry 72 for cooperating with tip tapered portion 30a in choking flow of polymer in a conical flow space 75 therebetween. Tapered entry 72 terminates in a cylindrical bore 74 that cooperates with tapered portion 30b of second tip 46 in forming an annular space 76.

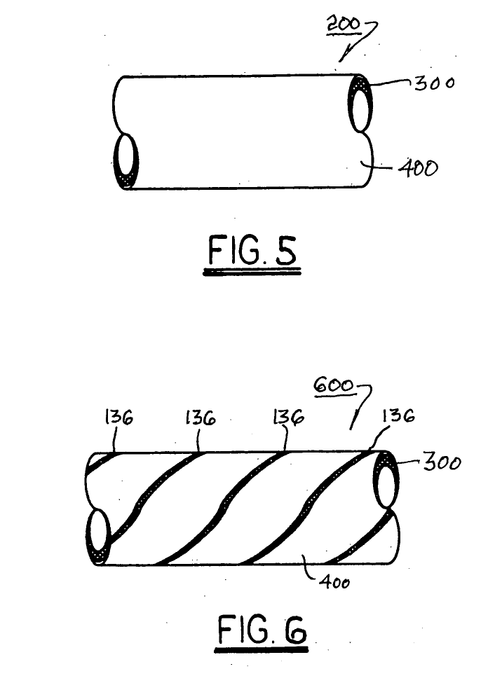

A source (not shown) of molten secondary polymer is connected to flow path 53 via a radial port 55 in second body section 70 and a cavity 57 in retainer 51. Flow path 53 merges with flow space 75 wherein a very thin “skin” layer of molten second polymer is caused to be annularly and coaxially joined to the molten primary polymer, resulting in a flowing element 200 having a cylinder of primary polymer 300 surrounded by a cylindrical skin of secondary polymer 400, as shown in FIG. 5.

Second body section 70 of body element 13 is further provided with a second counterbore 78, and a wear plate 82 is disposed therein. Preferably, wear plate 82 is formed of a dry-lubricating, low-friction material, for example, bronze or a polymer, for example, a polyimide polymer such as Torlon or Rulon.

A rotatable die sub-assembly 90 is coaxially disposed in counterbore 78. Sub-assembly 90 includes a hub 92 for receiving bearings assembly 96, preferably ball or roller bearings, and an axial bore 98 for passage of elements extruded from assembly 10.

Hub flange 102 has a toothed periphery 108 for cooperating with a conventional worm gear 110 driven by a controlled drive element of an actuation assembly 113 to cause hub 92 to rotate at a desired speed, in known fashion.

Hub 92 is further provided with an axial face 114 and a shallow counterbore 116. A novel shaping die 118 in accordance with the invention is disposed between face 114 and wear plate 82 and is urged against wear plate 82 by spring means disposed in counterbore 116, preferably a Belleville washer 120. Die 118 is pinned to hub 92 via axial pins 122 such that the pins cause the die to rotate with the hub but also allow the die to advance axially along the pins in response to force from the Belleville washer as the wear plate diminishes in axial dimension through use of the apparatus. Thus an effective seal is maintained against leakage of polymer between the die and the wear plate over extensive wear of the wear plate. Die sub-assembly 90 is secured in place via an outer ring 124 bolted via bolts 126 to second body section 70.

A tapered bore 130 within die 118 cooperates with tip portion 30c of second tip 46 to further choke the flow of coaxial element 200 into an extrusion opening 132.

Referring to FIGS. 3 and 6, in a first die embodiment 118a in accordance with the invention, annular opening 132 is provided with at least one inwardly-extending protrusion 134 having a radial length sufficient to plow a furrow 136 in the secondary polymer skin layer 400, exposing the primary polymer 300 underneath. The furrow 136 survives the extrusion and represents a permanent breach in layer 400 of extruded element 600. When the primary and secondary polymers are of contrasting colors or optical densities, the furrow is perceived by a viewer as a stripe in the extrusion. Obviously, a plurality of teeth 134 may be provided, corresponding to the number of stripes desired, for example, three as shown in FIGS. 3 and 6.

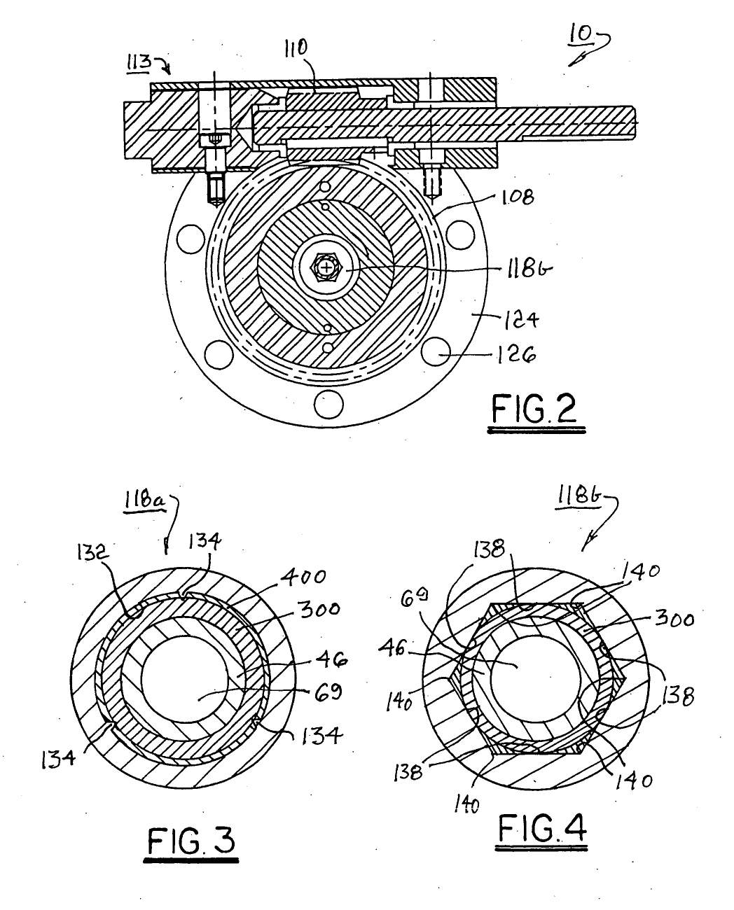

Referring to FIGS. 2 and 4, in a second die embodiment 118b in accordance with the invention, opening 132 is formed as a plurality of facets 138, for example, six, joined at internal corners 140, although a single facet 138 may be used to provide a single stripe. The faceted figure is sized such that the minimum diameter of the opening at the facets corresponds to approximately the outer diameter of primary polymer flow 300. As coaxial flow element 200 (FIG. 5) is forced through die 118b, the secondary polymer layer 400 is displaced laterally from the regions of the facet centers, exposing to view the primary polymer, and is forced into the facet corners 140. Preferably, compressed air is provided via opening 67 in tip 46 to maintain the cylindricity of layer 300 during such distortion of overlying layer 400. Thus, the extrusion displays an apparent striping of alternate shades of primary and secondary polymer. Again, a number of facets and corners may be provided corresponding to the number of stripes desired.

When worm gear 110 is not rotated, the stripe or stripes will simply be longitudinal of the extrusion. However, when activator assembly 113 is energized to drive gear 110, die 118a or 188b is rotated about axis 40, resulting in a helically or spirally striped extrusion.

Alternatively, core materials such as wires, rods, other tubes, lumber, and the like may be conveyed through axial passages 65,67,69 in known fashion and coated with either linear or spirally striped extrusion. Of course, by closing portion 52 of extrusion tip 46 in known fashion, a rod (not shown) may be extruded as element 300 having a linear or spiral stripe in its outer surface.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

1. An extrusion head assembly for continuous extrusion of an elongate element of a primary molten polymer and a secondary molten polymer, disposed in a layer coaxially around the primary molten polymer, wherein the secondary molten polymer layer is thinned or breached to visually expose a continuous stripe of the primary molten polymer underneath, the primary and secondary molten polymers differing visually and being supplied from first and second sources, comprising:
a) a fixed member for conveying said primary molten polymer and said secondary molten polymer in a coaxial annular stream axially of an axis of said head; and
b) a die sub-assembly rotatably disposed on said fixed member for receiving from said fixed member said annular stream of primary and secondary molten polymers and extruding said elongate element, said die sub-assembly including an extrusion die having an opening for extruding said elongate element, the periphery of said opening including means for varying the thickness of said secondary polymer layer at one or more selected angular locations of said die opening to form visual stripes in said elongate element resulting from said thickness varying.

2. An extrusion head assembly in accordance with claim 1 wherein said means for varying the thickness of said secondary polymer layer include at least one protrusion extending inwards from said periphery for forming a furrow in said layer to expose a stripe of said primary polymer underneath.

3. An extrusion head assembly in accordance with claim 2 comprising a plurality of said protrusions arranged angularly about said opening for forming a plurality of said furrows.

4. An extrusion head assembly in accordance with claim 2 wherein said stripe is formed spirally of said extrusion by rotating of said die sub-assembly.

5. An extrusion head assembly in accordance with claim 1 wherein said means for varying the thickness of said secondary polymer layer includes at least one facet for causing a thinning of said secondary polymer layer to expose a stripe of said primary polymer underneath.

6. An extrusion head assembly in accordance with claim 5 comprising a plurality of said facets arranged angularly about said opening for causing a plurality of said thinnings to expose a plurality of stripes of said primary polymer underneath.

7. An extrusion head assembly in accordance with claim 5 wherein said stripe is formed spirally of said extrusion by rotating of said die sub-assembly.

8. An extrusion die for forming at least one visual stripe in an extrusion of dissimilar first and second molten polymers arranged concentrically, a second polymer layer surrounding the first polymer, wherein an extrusion opening of said die includes at least one protrusion extending inwards from said periphery for forming a furrow in said layer to expose a strip of said primary polymer underneath.

9. An extrusion die for forming at least one visual stripe in an extrusion of dissimilar first and second molten polymers arranged concentrically, a second polymer layer surrounding the first polymer, wherein an extrusion opening of said die includes at least one facet for a thinning of said secondary polymer layer to expose a stripe of said primary polymer underneath.

10. A method for forming a visual longitudinal stripe in an elongate element having a cylindrical shape formed of a molten primary polymer surrounded by a coaxial molten secondary polymer, comprising the steps of:
a) providing a fixed member for conveying said primary molten polymer and said secondary molten polymer in a coaxial annular stream axially of an axis of said head; and
b) providing a die sub-assembly rotatably disposed on said fixed member for receiving from said fixed member said annular stream of primary and secondary molten polymers and extruding said elongate element, said die sub-assembly including an extrusion die having an opening for extruding said elongate element, the periphery of said opening including means for varying the thickness of said secondary polymer layer at one or more selected angular locations of said die opening to form visual stripes in said elongate element resulting from said thickness varying;
c) introducing said primary polymer into said fixed member;
d) forming said primary polymer into a shape;
e) introducing said secondary polymer into said fixed member;
f) arranging said secondary polymer into a layer surrounding said primary polymer; and
g) passing said layered shape through said die opening and past said means for varying the thickness of said secondary polymer layer to form said elongate element having said visual stripe resulting from said thickness varying in said secondary polymer layer.

11. A method in accordance with claim 10 comprising the further step of rotating said die during said passing step such that said elongate striped element is spirally striped.
